(19) United States
(12) Patent Application Publication
(10) Pub. No.: US 2007/0009237 A1
(43) Pub. Date: Jan. 11, 2007

(54) Disc player

(75) Inventor: Yoshiyuki Kunita, Osaka (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Osaka (JP)

(21) Appl. No.: 11/480,572

(22) Filed: Jul. 5, 2006

(30) Foreign Application Priority Data
Jul. 11, 2005 (JP) 2005-201261

(51) Int. Cl. H04N 5/00

(52) U.S. Cl. 386/125

(57) ABSTRACT

A disc player for playing files recorded on discs includes a skip list storage section, a registration section and a controller. The skip list storage section stores a skip list which includes information on a skip file which does not have to be played among files recorded on a mounted disc. The registration section selects the skip file from a recorded file list which includes information on files recorded on the mounted disc and registers the skip file to the skip list stored by the skip list storage section. The controller plays the files recorded on the mounted disc excepting the skip file. The skip list is deleted when the mounted disc is ejected.

### CROSS-REFERENCE TO RELATED APPLICATIONS

This application claims priority to Japanese Patent Application No. 2005-201261. The entire disclosure of Japanese Patent Application No. 2005-201261 is hereby incorporated herein by reference.

### BACKGROUND OF THE INVENTION

1. Field of the Invention

The present invention generally relates to a disc player. More specifically, the present invention relates to a disc player which includes a controller for playing files recorded on discs.

2. Background Information

Conventionally, disc players with consideration to users' convenience in playing discs have been proposed (see, for example, Japanese Laid-Open Publication No. 2001-243755).

An example of such disc players is a CD player with a disc changer which can be shared by a plurality of users. A user selects audio discs and registers the audio discs to a user file. The user also selects tracks which are not to be played (hereinafter referred to as “skip tracks”) for each of the audio discs and registers them. A user file and information on the skip tracks of the audio discs of the user file are associated to each other and are stored. For playing discs based on the user file, the user file selected by a user and the skip tracks which are associated to the user file are detected. Thus, the audio disc selected by the user can be played without playing the skip tracks. When the disc player is shared by a plurality of users, each of the users can select the user file and the skip tracks set for oneself to play an optical disc without playing the skip tracks registered by oneself.

In the above-described conventional disc player, users select and register skip tracks so that a disc can be played without playing the tracks not to be played.

However, it is not disclosed that how the skip tracks, which are registered by the user, are managed thereafter in the above conventional disc player.

Specifically, the above conventional disc player is based on the premise that a CD player with a disc changer is shared by a plurality of users. Thus, a storage section (for example, a memory) for storing the skip tracks has to store the skip tracks for the discs to be mounted on the CD player by the number of user files of the plurality of users who share the CD player. This requires the storage section to have a large capacity. When the memory capacity is full, information on the skip tracks cannot be newly registered. Thus, the information on the skip tracks registered by the users has to be deleted manually by the users. This requires cumbersome management.

An object of the present invention is to solve this problem by providing a disc player in which management of files registered by users that do not have to be played is performed. Specifically, registration of the files, which do not have to be reproduced, are deleted in accordance with a situation desired without requiring the user to pay attention. This invention addresses this need in the art as well as other needs, which will become apparent to those skilled in the art from this disclosure.

### SUMMARY OF THE INVENTION

The disc player of the present invention is a disc player for playing files recorded on discs that includes a skip list storage section, a registration section and a controller. The skip list storage section stores a skip list, which includes information on a skip file, which does not have to be played among files recorded on a mounted disc. The registration section selects the skip file from a recorded file list which includes information on files recorded on the mounted disc and registers the skip file to the skip list stored by the skip list storage section. The controller plays the files recorded on the mounted disc excepting the skip file. The skip list is deleted when the mounted disc is ejected.

According to the present invention having such features, by only registering and storing the skip file, which is not necessary for the user to play, to the skip list, for playing the disc, the skip file stored in the skip list can be removed from an object of play and the play control is performed only for the rest of the files. Thus, the user can perform a manipulation for play without paying attention to the skip file. The skip file refers not only to a file which is not desired by the user to play but also to a file having the size, bit rate, sampling frequency or the like that are not covered by the specs capable of being played by the disc player, or a file broken due to damage and the like. Further, according to the present invention, the skip list registered in the skip list storage section is deleted when the disc is ejected from the disc player. Thus, the skip list storage section can be a memory with a small capacity. Moreover, since the skip list is deleted when the disc is ejected from the disc player, a cumbersome management as in the conventional disc player is no longer necessary.

The disc player of the present invention is a disc player for playing files recorded on discs that includes a skip list storage section, a registration section and a controller. The skip list storage section stores skip lists corresponding to a plurality of discs in association with identifying information of the discs. Each of the skip lists includes information on a skip file which does not have to be played among files recorded on the disc corresponding thereto. The registration section selects the skip file from a recorded file list which includes information on files recorded on a mounted disc and registers the skip file to the skip list stored by the skip list storage section. The controller plays the files recorded on the mounted disc excepting the skip file and deletes at least one of the skip lists based on a predetermined priority to store the skip list of the mounted disc when a storage capacity for the skip lists which are stored in the skip list storage section is full.

Herein, the at least one of the skip lists may include the skip list of the disc having a lower use frequency in the past. If the use frequency is low, it can be assumed that necessity for the skip list is low.

Further, the at least one of the skip lists may include the skip list of the disc having a smaller number of registrations of the skip files. If the number of registrations of the skip files is small, even in the case where the skip list of the disc has to be registered again, the skip files are registered with fewer number of registration processes, and thus, the user's effort is saved.

Moreover, the at least one of the skip lists may include the skip list of the disc having the oldest play history among the play histories for the discs. If the play history is old, it can be assumed that the necessity for the skip list is low.

Further, the at least one of the skip lists may include the skip list of the disc having a lower use frequency in the past and a smaller number of registrations of the skip files. If the use frequency of the past is the same, the one with the smaller number of registrations of the skip files is deleted in order to save the user's effort because even in the case where the skip list of the disc has to be registered again, the skip files are registered with fewer number of registration processes.

Moreover, the at least one of the skip lists may include the skip list of the disc further having the oldest play history among the play histories for the discs. Even though the use frequency of the past is the same and the number of the skip files is the same, it can be assumed that the necessity for the skip list is low if the play history is old.

Further, the priority in deleting the at least one of the skip lists from the skip list storage section may be selected by a user from an order of the use frequency of the discs in the past, an order of the number of registrations of the skip files of the discs, an order of oldness of the play histories of the discs, and combinations thereof. By having the user select the priority in deleting the skip lists with a free hand, the skip list is deleted in accordance with the situation of use by the user.

Moreover, according to the disc player of the present invention, the controller may be formed to automatically register the skip file to the skip list when actual data is not able to be played when the mounted disc is played. In such a case, a user may set the automatic registration to be valid or invalid. By automatically registering the skip file when actual data can not be played, the user can perform a general operation for play without paying attention to a failure in a file recorded on the disc, if there is one.

According to the present invention, by only registering and storing a skip file, which is not necessary for a user to play, to a skip list, for reproducing the disc, the files stored in the skip list storage section are removed from an object of play and play control is performed only for the rest of the files. Thus, the user can perform a manipulation for play without paying attention to the skip file. Moreover, since the skip list stored in the skip list storage section is deleted when the disc is ejected from the disc player, a cumbersome management as in the conventional disc player is no longer necessary.

Further, according to the present invention, when a storage capacity for skip lists for discs which are stored in the skip list storage section is full, a skip list of a disc is deleted from the skip list storage section in accordance with a priority predetermined by the user for storing a skip list of a new disc. Thus, the skip list is deleted in accordance with a situation of use by the user.

Moreover, according to the present invention, by automatically registering the skip file to the skip list when actual data cannot be played, the user can perform an operation for play without paying attention to a failure in a file recorded on the disc.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a diagram showing a system structure of a DVD player which is an embodiment of a disc player according to the present invention;

FIG. 2 is a diagram illustrating an example of a skip list registration screen for registering skip files which do not have to be played to a skip list storage section;

FIG. 3 is a diagram illustrating an example of a recorded file list screen for an optical disc;

FIG. 4 is a diagram illustrating a process of sequential play after the skip files which are registered to the skip list are removed, and the rest of the files are played sequentially;

FIGS. 5 is a flow diagram showing an operation process according to Example 2 for deleting the skip lists from that of the optical disc having the smallest use frequency in the past;

FIG. 6 is a diagram illustrating the total use numbers of the optical discs which are stored in the skip list storage area;

FIG. 7 is a flow diagram showing an operation process according to Example 3 for deleting the skip lists from that of the optical disc having the smallest number of registration of the skip files;

FIG. 8 is a diagram illustrating an example of the registration numbers of the skip files of the optical discs which are stored in the skip list storage area;

FIG. 9A is a diagram for illustrating an example of a skip list deleting condition setting screen for allowing a user to select a management method according to the examples; and

FIG. 9B is a diagram illustrating an example of an automatic registration selection screen for allowing a user to select whether or not to set automatic registration.

### DETAILED DESCRIPTION OF THE PREFERRED EMBODIMENTS

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

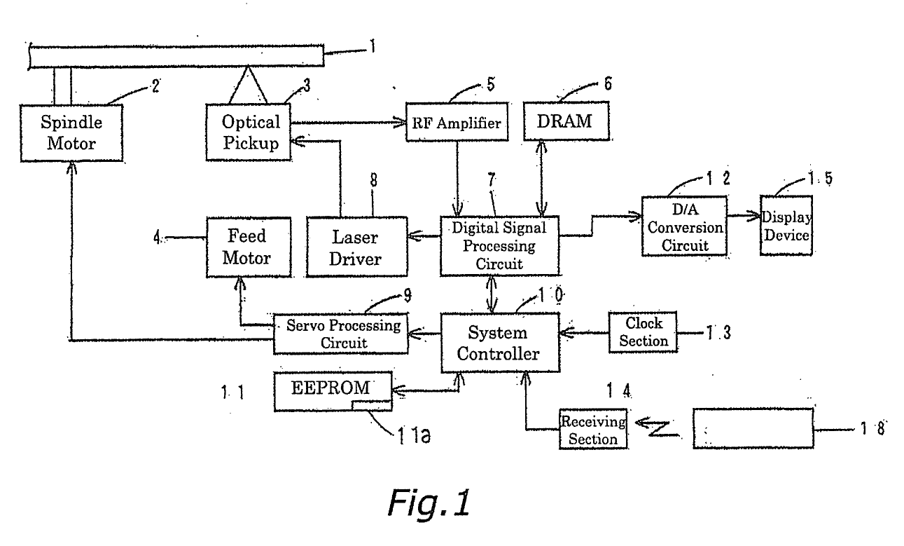

FIG. 1 shows a system structure of a digital versatile disc (DVD) player, which is an embodiment of the disc player according to the present invention. Specifically, FIG. 1 shows a play-only device for playing optical discs on which video and audio files such as compact disc digital audio (CD-DA), MPEG1 Audio Layer-3 (MP3), Joint Photographic Coding Experts Group (JPEG), Windows^{TR} Media Audio (WMA), DivX (image compressing format technique), and the like are recorded.

An output from an optical pickup 3 for reading out data from a mounted optical disc 1 is connected to a digital signal processing circuit 7 via an RF amplifier 5. An output from the digital signal processing circuit 7 is connected to a laser driver 8 for controlling a laser output for reading out data by the optical pickup 3. An output from a servo processing circuit 9 is connected to a feed motor 4 for moving the optical pickup 3 in a radial direction of the optical disc 1, and to a spindle motor 2 for rotationally driving the optical disc 1. The digital signal processing circuit 7 and the servo processing circuit 9 are bidirectionally connected to a system controller 10 which controls an operation of the entire player.

A buffer, for example, an SDRAM 6 is connected bidirectionally to the digital signal processing circuit 7 for temporarily storing data at a play operation. Further, a D/A conversion circuit 12 for converting digital data into analog data and outputting to a display device 15 such as a CRT is also connected to the digital signal processing circuit 7.

An EEPROM 11 is connected bidirectionally to the system controller 10 for storing inherent information such as parameters of the optical disc 1, parameters of laser power, and the like. Also, a clock section 13 for clocking current time is connected to the system controller 10. Further, a receiving section 14 for receiving an infrared radiation signal from a remote control 18 having numerical keys and other functional keys is connected to the system controller 10.

The digital signal processing circuit 7 converts an RF signal output from the RF amplifier 5 into digital data and performs a signal demodulation process and an error correction process in accordance with a disc format of the optical disc 1 to generate the data and store the data to the SDRAM 6. Further, the digital signal processing circuit 7 also performs a process to read out the stored data and output to the D/A conversion circuit 12.

The system controller 10 reads out control information (file information and the like) from a predetermined area of the optical disc 1 when the optical disc 1 is mounted, and records the information on a predetermined area of the SDRAM 6. Thereafter, the system controller 10 performs a play process based on the control information stored in the predetermined area of the SDRAM 6.

In the above structure, the EEPROM 11 includes a skip list storage area 11a. The skip list storage area 11a is for storing information on specific files as a skip list among files recorded on the mounted optical disc 1 that do not have to be reproduced (hereinafter referred to as “skip files”). In other words, the skip list includes information on the files to be skipped. The skip list storage area 11a stores a plurality of the skip lists corresponding to a plurality of the optical discs 1.

When the disc 1 is played, the system controller 10 consider the skip files of the disc 1 which are stored in the skip list storage area 11a to be out of the object for play, and performs play control with only the rest of the files.

For example, when an MP3 file is played, the play may fail because data is damaged due to a failure in encoding, degradation of the optical disc 1 or the like, or because the specs required by the object file are not satisfied by the player, and so on. Further, the files recorded on the optical disc 1 may include some files which are considered unnecessary to play by the user. In the DVD player of the present embodiment, the skip files are concealed by registering them to the skip list storage area 11a, thereby allowing the user not to pay attention to the skip files in performing general operations.

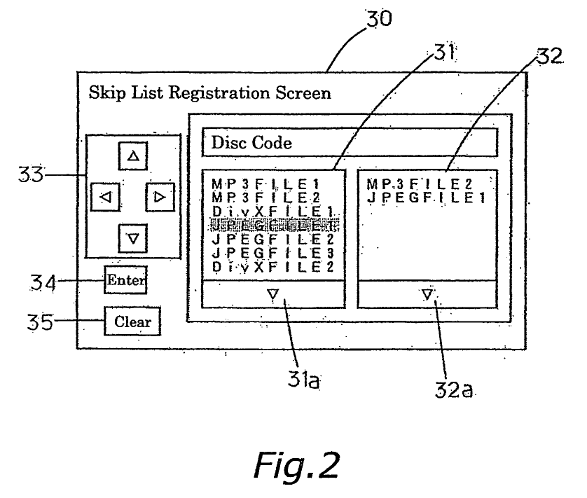

FIG. 2 shows a skip list registration screen 30 for registering skip files to the skip list storage area 11a. The registration of skip files using the skip list registration screen 30 is performed by the user by operating the remote control 18.

In the example shown in FIG. 2, a recorded file list screen 31, which is read out from the mounted optical disc 1, is displayed in a left part of a frame in a center of the skip list registration screen 30. In a right part of the frame, a skip list screen 32 is displayed. Outside the frame, cursor keys 33 of up, down, left, and right, an enter key 34, a clear key 35 and the like are displayed on the left-hand side. In an upper part of the frame, identifying information (disc code) of the optical disc 1 to be registered is displayed. The skip list registered at the skip list screen 32 is stored in the skip list storage area 11a in association with the disc code.

When displayed as such, one of the files in the recorded file list screen 31 is highlighted. The user moves a highlight up and down using a cursor key 31a in the recorded file list screen 31 or the cursor keys 33 outside the frame to move the highlight to a position of a desired file. Then, the user operates the enter key 34, and the selected file is registered to the skip list screen 32 on the right hand side. In the example shown in FIG. 2, a file of TRACK 2 (MP3FILE2), and a file of TRACK 4 (JPEGFILE1) are registered to the skip list. In the recorded file list screen 31, the list of the recorded files is displayed in the order of tracks in a downward direction.

As described above, the registration process for registering the skip files to the skip list storage area 11a is described as a manual operation of the user. However, automatic registration under control by the system controller 10 itself may be added to such a registration process by the manual operation. This means that the system controller 10 is formed to automatically register files with actual data that have not been able to be played when the mounted optical disc 1 is played to a skip list of the corresponding optical disc 1 in the skip list storage area 11a. The files with actual data that can not be played will be registered by the user anyway as skip files from the skip list registration screen 30 shown in FIG. 2. Thus, automatic registration of such files can save time and effort.

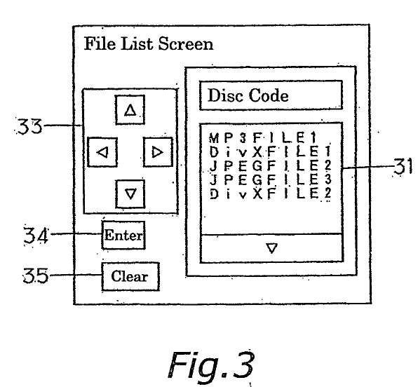

With the optical disc 1 having the skip list registered as described above, when only the recorded file list screen 31 of the optical disc 1 is opened from a menu screen or the like (not shown), the recorded file list screen is as shown in FIG. 3. As is clear from the comparison with the recorded file list screen 31 shown in FIG. 2, the skip files registered in the skip list are not shown.

The skip files registered to the skip list screen 32 can be deleted from the skip list by using the clear key 35 or the like. The skip files registered to the skip list are rendered unrecognizable to the user unless they are removed from the skip list by using the clear key 35 or the like.

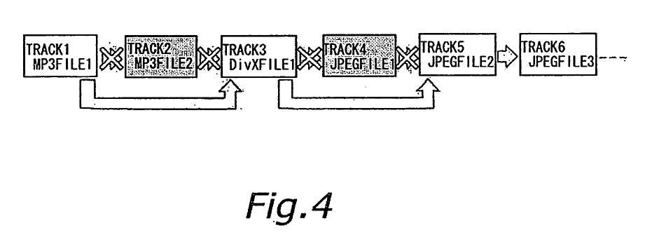

Referring to FIG. 4, when the optical disc 1 is attempted to be played sequentially in accordance with the list displayed on the recorded file list screen 31, after play of TRACK 1 (MP3FILE1), TRACK 2 (MP3FILE2) is skipped, and TRACK 3 (DivXFILE1) is played. Then, TRACK 4 (JPEGFILE1) is skipped, and TRACK 5 (JPEGFILE2) is played. Then, TRACK 6 (JPEGFILE3) is played sequentially in accordance with the order registered to the recorded file list. This means that the skip files which are not an object for reproduction are excluded, and the turn of play is jumped only among the rest of the files. Further, when track search is being performed, and TRACK 2 is designated, the search operation is regarded as invalid, and re-entering is prompted.

The DVD player of the present embodiment performs the above-described play process. However, in such a case there is a limit in the capacity of the skip list storage area 11a of the EEPROM 11. Thus, the skip list registered for each disc has to be managed. Hereinafter, examples of methods for managing (herein, management methods for deleting) will be described.

### EXAMPLE 1

Example 1 is the most basic method for managing the skip lists.

More specifically, the skip list storage area 11a stores only one skip list associated with one optical disc 1. The system controller 10 is formed to delete the skip list stored in the skip list storage area 11a when the mounted optical disc 1 is ejected from the player. In this way, the skip list storage area 11a always stores only the skip list for the mounted optical disc 1.

### EXAMPLE 2

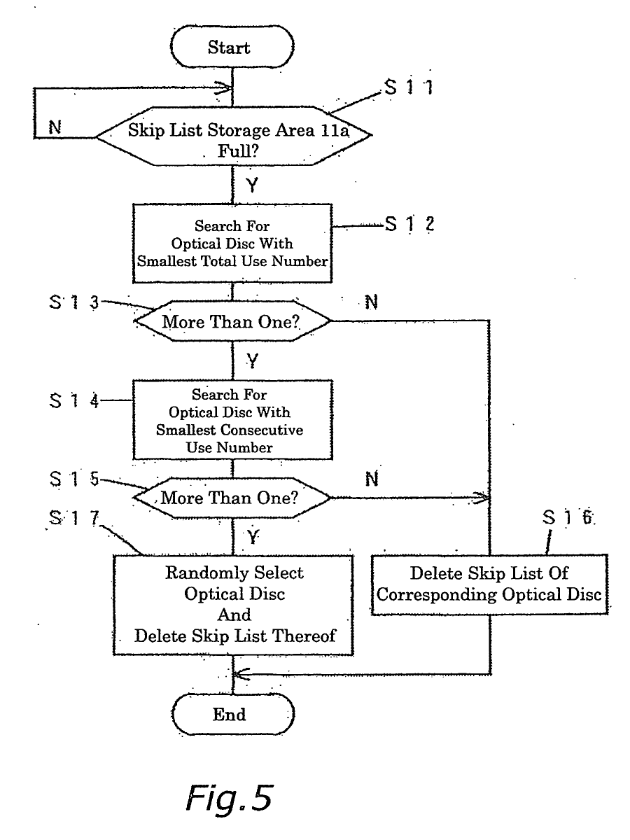

Referring to FIG. 5, Example 2 is an example in which the skip list storage area 11a stores a plurality of skip lists associated with a plurality of optical discs 1. In this example, when a storage capacity for the skip lists of the optical discs 1 is full, the skip lists of the optical disc 1 with the lowest frequency of use in the past are deleted.

The frequency of use is determined based on the total number of uses in the past with consideration to the number of times that the optical discs 1 is used consecutively (consecutive use number). The consecutive use number is counted separately from the total use number. It is regarded as continuous use when the mounted optical disc 1 is repeatedly played and stopped without being ejected. It is also regarded as consecutive use when the optical disc is ejected from the player once, then power of the player is turned off and turned on again, and the same optical disc is again mounted to the player and played even though another optical disc is mounted at some point, as long as it is not played. The consecutive use number is incremented in such case.

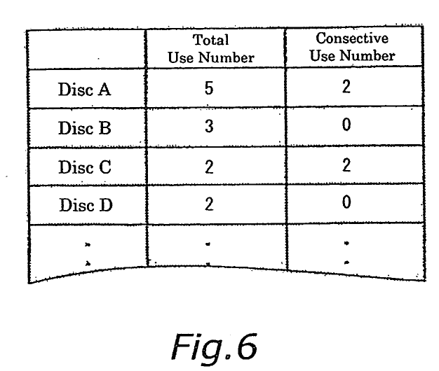

Counted value of the total use number including the consecutive use number is incremented by one when the pickup 3 reads out the control information (file information and the like) of the optical disc 1 and the play is started. The counted value of the total use number (including the consecutive use number) may be stored in association with the disc code of each optical disc 1 in the skip list storage area 11a. Hereinafter, the example will be described specifically with reference to a flow diagram shown in FIG. 5 and an example of the total use number shown in FIG. 6.

When the storage capacity for the skip lists for the optical discs which are stored in the skip list storage area 11a is full (determined YES at step S11), the system controller 10 searches for the optical disc with the smallest total use number in the past with reference to the total use numbers of the optical discs 1 which are stored in the skip list storage area 11a (step S12). As a result, when there is only one optical disc 1 having the smallest total use number (when it is determined No at step S13), the skip list of the corresponding optical disc is deleted from the skip list storage area 11a (step S16).

When there are a plurality of optical discs 1 having the smallest total use number (when it is determined YES at step S13), the optical disc 1 having the smallest consecutive use number is searched for from the plurality of optical discs 1 (step S14). As a result, when there is only one optical disc 1 having the smallest consecutive use number (when it is determined YES at step S15), the skip list of the corresponding optical disc 1 is deleted from the skip list storage area 11a (step S16).

For example, if the total use numbers and the consecutive use numbers of the optical discs 1 are as shown in FIG. 6, disc C and disc D have the smallest total use number, two. However, the consecutive use number is two for the disc C and zero for disc D. The disc D has never played consecutively. Therefore, the skip list of the disc D which has the consecutive use number of zero is deleted from the skip list storage area 11a.

If there are a plurality of optical discs 1 having the smallest consecutive use number (if it is determined YES at step S15), one optical disc 1 is selected at random from the plurality of the optical discs, and the skip list of the optical disc 1 is deleted from the skip list storage area 11a (step S17).

Regarding the total use number, a latest period of time for a certain length (for example, at last one month) may be set, and the number of times of use during that period may be counted as the total use number. Specifically, the total use number for the last one month may be always kept by subtracting the number of times of use before the period from the total use number. In such a case, for managing the old number of use, the current time clocked by the clock section 13 may be used for managing date and time of use of the optical discs 1. In this way, the total use number can reflect the recent conditions of use by the user (in the last one month).

When the storage capacity for the skip lists of the optical discs 1 is full, the skip lists of the optical discs 1 that have the oldest usage history (play history) may be deleted instead of deleting the skip lists of the optical disc 1 with the lowest frequency of use in the past as described above.

The usage history for each optical disc 1 may be updated when the pickup 3 reads out the control information (file information and the like) of the optical disc 1 and the play is started, for example, and may be stored in association with the disc code of each optical disc 1 in the skip list storage area 11a. For example, the usage history is based on an order information of an order of play of the optical disc 1 in the past, which is associated to the disc code of the optical disc 1. When a new optical disc 1 is played, the order information of the optical disc 1 is set as 1, and the order information of the optical discs 1, which have already been stored in the skip list, are respectively incremented by 1. Then, when the storage capacity for the skip lists for the optical discs 1 which are stored in the skip list storage area 11a is full, the system controller 10 searches for the optical disc 1 having the largest number with reference to the order information of the usage history of the optical discs 1 which are stored in the skip list storage area 11a. The system controller 10 deletes the skip list of the corresponding optical disc 1 from the skip list storage area 11a.

### EXAMPLE 3

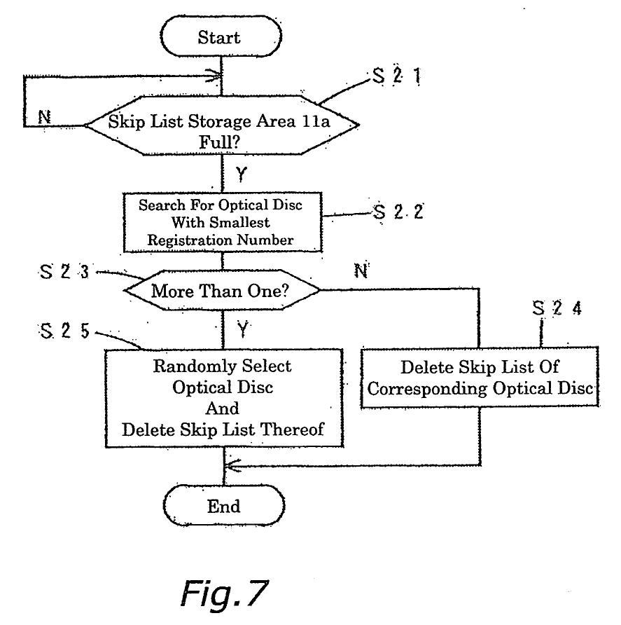

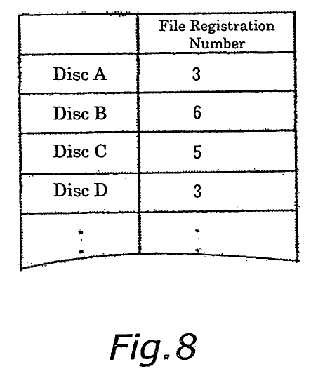

Referring to FIG. 7, Example 3 is an example in which the skip list storage area 11a stores a plurality of skip lists corresponding to a plurality of optical discs 1. In this example, when the storage capacity for the skip lists of the optical discs 1 is full, the skip list of the optical disc 1 having the smallest number of registration of skip files is deleted. Hereinafter, the example will be described specifically with reference to a flow diagram shown in FIG. 7 and examples of registration numbers shown in FIG. 8.

When the storage capacity for the skip lists, which are stored in the skip list storage area 11a is full (when it is determined YES at step S21), the system controller 10 searches for an optical disc 1 having the smallest number of registration of skip files with reference to the number of file registration to the skip lists of the optical disc 1 which are stored in the skip list storage area (step S22). As a result, when there is only one optical disc 1 having the smallest number of file registration (when it is determined NO at step S23), the skip list of the corresponding optical disc 1 is deleted from the skip list storage area 11a (step S24).

When there are a plurality of optical discs 1 having the smallest number of registration (when it is determined YES at step S23), one of the optical discs 1 is selected from the plurality of optical discs 1 at random, and the skip list of the optical disc is deleted from the skip list storage area 11a (step S25). For example, if the numbers of registration for the optical discs are as shown in FIG. 8, disc A and disc D have the smallest number of registration, 3. In such case, the skip list of either the disc A or the disc D is randomly selected and deleted.

### EXAMPLE 4

Example 4 is Example 2 combined with Example 3. This means that the order for deleting is determined first based on the frequency of use, and when it is impossible to decide on one optical disc 1 based on the frequency of use, the numbers of registration are taken into consideration. Hereinafter, the example will be described with reference to flow diagrams shown in FIGS. 5 and 6.

When the storage capacity of the skip list storage area 11a for the skip lists of the optical discs 1 is full (when it is determined YES at step S11), the system controller 10 searches for the optical disc 1 having the smallest total use number in the past with reference to the total use numbers for optical discs 1 which are stored in the skip list storage area 11 a (step S12). As a result, when there is only one optical disc 1 having the smallest total use number (when it is determined No at step S13), the skip list of the corresponding optical disc 1 is deleted from the skip list storage area 11a (step S16).

When there are a plurality of optical discs 1 having the smallest total use number (when it is determined YES at step S13), the optical disc 1 having the smallest consecutive use number is searched for from the plurality of optical discs 1 (step S14). As a result, when there is only one optical disc 1 having the smallest consecutive use number (when it is determined YES at step S15), the skip list of the corresponding optical disc 1 is deleted from the skip list storage area 11a (step S16).

If there are a plurality of optical discs 1 having the smallest consecutive use number (if it is determined YES at step S15), the process moves to step S22 shown in FIG. 7 at this point. From the plurality of optical discs 1 having the smallest consecutive use number, an optical disc 1 having the smallest number of registration of the skip files is searched for with reference to the number of files registered to the skip lists. As a result, when there is only one optical disc 1 with the smallest number of registration (when it is determined NO at step S23), the skip list of the corresponding optical disc 1 is deleted from the skip list storage area 11a (step S24).

When there are still a plurality of optical discs 1 having the smallest number of registration at this point (when it is determined YES at step S23), one of the optical discs 1 is selected from the plurality of optical discs 1 at random, and the skip list of the optical disc 1 is deleted from the skip list storage area 11a (step S25).

Instead of selecting an optical disc 1 at random and deleting the skip list of the optical disc 1 from the skip list storage area 11a at step S25, the skip lists of the optical discs 1 may be deleted from that of the optical disc 1 having the oldest usage history in the past as described in Example 2.

### EXAMPLE 5

Example 5 is Example 3 combined with Example 2 and opposite to the above Example 4. This means that the order for deleting is determined first based on the numbers of registration, and when it is impossible to decide on one optical disc 1 based on the numbers of registration, the usage frequency is taken into consideration. Hereinafter, the example will be described with reference to flow diagrams shown in FIGS. 5 and 6.

When the storage capacity of the skip list storage area 11a for the skip lists of the optical discs 1 is full (when it is determined YES at step S21), the system controller 10 searches for an optical disc 1 having the smallest number of registration of skip files with reference to the number of files registered to the skip lists for the optical discs 1 which are stored in the skip list storage area 11a (step S22). As a result, when there is only one optical disc 1 with the smallest number of registration (when it is determined NO at step S23), the skip list of the corresponding optical disc 1 is deleted from the skip list storage area 11a (step S24).

When there are a plurality of optical discs 1 with the smallest number of registration (when it is determined YES at step S23), the process moves to step S12 shown in FIG. 5 at this point. From the plurality of optical discs 1 having the smallest number of registration, an optical disc 1 with the smallest total use number is searched for with reference to the total use numbers in the past. As a result, when there is only one optical disc 1 having the smallest total use number (when it is determined No at step S13), the skip list of the corresponding optical disc 1 is deleted from the skip list storage area 11a (step S16).

When there are a plurality of optical discs 1 having the smallest total use number (when it is determined YES at step S13), the optical disc 1 having the smallest consecutive use number is searched for from the plurality of optical discs 1 (step S14). As a result, when there is only one optical disc 1 having the smallest consecutive use number (when it is determined YES at step S15), the skip list of the corresponding optical disc 1 is deleted from the skip list storage area 11a (step S16).

If there are a plurality of optical discs 1 having the smallest consecutive use number (if it is determined YES at step S15), one optical disc 1 is selected at random from the plurality of optical discs 1, and the skip list of the optical disc 1 is deleted from the skip list storage area 11a (step S17).

Instead of selecting an optical disc 1 at random and deleting the skip list of the optical disc 1 from the skip list storage area 11a at step S17, the skip lists of the optical discs 1 may be deleted from that of the optical disc 1 having the oldest usage history in the past as described in Example 2.

The examples of management method of deleting skip lists from the skip list storage area 11a of the EEPROM 11 have been described above. The priority in selecting the examples of the managing methods to be used may be previously set in the player. However, it is convenient if the user can choose with a free hand. Therefore, in the present embodiment, the examples of the management methods can be selected by the users.

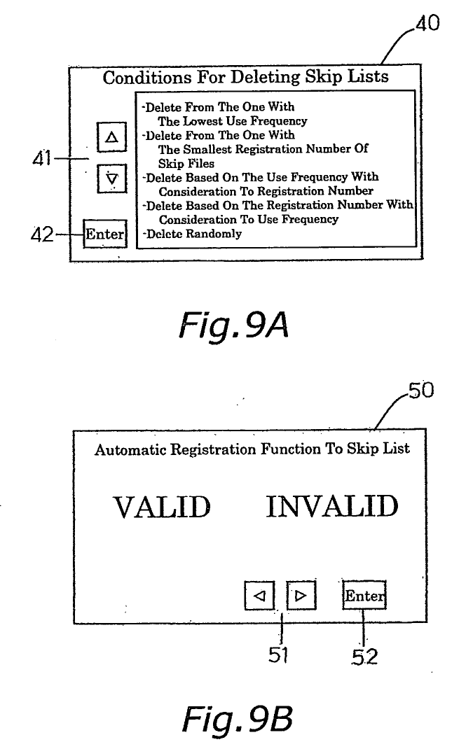

FIG. 9A shows a skip list deletion condition setting screen 40 for allowing users to select one of the examples of the management method. The condition setting using the skip list deletion condition setting screen 40 is performed by the user by manipulating the remote control 18.

In the example shown in FIG. 9A, five conditions are shown as conditions for deleting skip lists. The five conditions include: “Delete from the one with the lowest use frequency”; “Delete from the one with the smallest registration number of skip files”; “Delete based on the use frequency with consideration to registration number”; “Delete based on the registration number with consideration to use frequency”; and “Delete randomly”. The user can choose one from these five conditions.

In such a display, one condition is highlighted. The user can move the highlight up or down using a cursor key 41 within the screen to move the highlight to a desired condition, and press an enter key 42 to set the skip list deleting condition. The system controller 10 performs a deleting process according to one of the examples as described above (the example for “Delete randomly” has not been described above) in accordance with the set condition.

The conditions for deleting the skip lists are not limited to the above-mentioned five conditions. For example, “delete from the one of the optical disc 1 having the oldest usage history” may be added.

Further, an opportunity to select whether or not to perform the process for automatically registering the files when actual data cannot be played may be provided to the user.

FIG. 9B shows an automatic registration selection screen 50 for allowing the user to select whether to set automatic registration. Selecting automatic registration using the automatic registration selection screen 50 is performed by the user by manipulating the remote control 18. Either valid or invalid is highlighted. The user can move the highlight using a cursor key 51 within the screen to move the highlight toward right or left to move the highlight on the valid or invalid, and manipulate an enter key 52. In this way, whether or not to perform automatic registration is set.

### General Interpretation of Terms

An understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Terms that are expressed as “means-plus function” in the claims should include any structure that can be utilized to carry out the function of that part of the present invention. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A disc player for playing files recorded on discs, comprising:
a skip list storage section for storing a skip list which includes information on a skip file which does not have to be played among files recorded on a mounted disc;
a registration section for selecting the skip file from a recorded file list which includes information on files recorded on the mounted disc, and for registering the skip file to the skip list stored by the skip list storage section; and
a controller for playing the files recorded on the mounted disc excepting the skip file,
the skip list being deleted when the mounted disc is ejected.

2. A disc player for playing files recorded on discs, comprising:
a skip list storage section..for storing skip lists corresponding to a plurality of discs in association with identifying information of the discs, each of the skip lists including information on a skip file which does not have to be played among files recorded on the disc corresponding thereto;
a registration section for selecting the skip file from a recorded file list which includes information on files recorded on a mounted disc, and for registering the skip file to the skip list stored by the skip list storage section; and
a controller for playing the files recorded on the mounted disc excepting the skip file, and for deleting at least one of the skip lists based on a predetermined priority to store the skip list of the mounted disc when a storage capacity for the skip lists which are stored in the skip list storage section is full.

3. A disc player according to claim 2, wherein
the at least one of the skip lists includes the skip list of the disc having a lower use frequency in the past.

4. A disc player according to claim 2, wherein
the at least one of the skip lists includes the skip list of the disc having a smaller number of registrations of the skip files.

5. A disc player according to claim 2, wherein
the at least one of the skip lists includes the skip list of the disc having the oldest play history among play histories of the discs.

6. A disc player according to claim 2, wherein
the at least one of the skip lists includes the skip list of the disc having a lower use frequency in the past and a smaller number of registrations of the skip files.

7. A disc player according to claim 6, wherein
the at least one of the skip lists includes the skip list of the disc further having the oldest play history among play histories of the discs.

8. A disc player according to claim 2, wherein
the priority in deleting the at least one of the skip lists from the skip list storage section is selected by a user from one of the order of the use frequency of the discs in the past, the order of the number of registration of the skip files of the discs and the order of oldness of the play histories of the discs, or combinations thereof.

9. A disc player according to claim 8, wherein
the disc player is a play-only device.

10. A disc player according to claim 1, wherein
the controller automatically registers the skip file to the skip list when actual data is not able to be played when the mounted disc is played.

11. A disc player according to claim 10, wherein
a user can set the automatic registration to be valid or invalid.

12. A disc player according to claim 2, wherein
the controller automatically registers the skip file to the skip list when actual data is not able to be played when the mounted disc is played.

13. A disc player according to claim 12, wherein
a user can set the automatic registration to be valid or invalid.
